(19) United States
(12) Patent Application Publication
(10) Pub. No.: US 2004/0054548 A1
(43) Pub. Date: Mar. 18, 2004

(54) System and method for changing a value assigned to a value bearer

(76) Inventors: Alexander Hubertus Leopold Haffmans, Amsterdam (NL); Leopold Hendricus Weijzig, Zwolle (NL); Hendricus Antonius De Wijs, Amstelveen (NL)

Correspondence Address: Russell D Orkin, 700 Koppers Building, 436 Seventh Avenue, Pittsburgh, PA, 15219-1818, US

(21) Appl. No.: 10/312,795

(22) PCT Filed: Jun. 28, 2001
(86) PCT No.: PCT/EP01/07394

(30) Foreign Application Priority Data
Jun. 28, 2000 (NL) 1015556
Oct. 2, 2000 (NL) 1016309

(51) Int. Cl. G06F 17/60

(52) U.S. Cl. 705/1

(57) ABSTRACT

The present invention relates to a system for changing the initial values assigned to one or more value bearers, comprising:—memory means for storing data representative of the initial value assigned to a value bearer, input means for inputting one or more rating values for a particular event or a particular fact; —processing means for modifying in predetermined manner, subject to the inputted rating values, the initial values assigned to the value bearers and storing the changed values assigned to the value bearers in the memory means.

The present invention relates to a system and method for changing a value assigned to a value bearer, or determining a realistic value therefor.

The change in a market value assigned to a share on the basis of supply and demand is generally known. The value of the share is expressed in the share price which comes about on the stock exchange as a result of supply and demand of a large number of parties.

A drawback hereof is that price movements can sometimes assume unrealistic forms, i.e. the share price is based more on emotion or sentiment than on rational considerations. This can cause excesses such as a crash and the like which can undermine the political as well as the economic stability in the world.

The present invention has for its object to provide a system and method for changing a value assigned to a value bearer, wherein the above stated drawbacks are obviated.

According to a first aspect of the invention there is provided a system for changing the initial values assigned to one or more value bearers, comprising:

memory means for storing data representative of the initial value assigned to a value bearer,

input means for inputting one or more rating values for a particular event or a particular fact;

processing means for modifying in predetermined manner, subject to the inputted rating values, the initial values assigned to the value bearers and storing the changed values assigned to the value bearers in the memory means. The value or price of the value bearer depends on a predetermined function, so that undesirable influences resulting from supply and demand do not occur. The value or price of the value bearer can moreover come about in a transparent manner since the function(s) are known in advance. The value bearer may for instance express the rating of companies. Other random applications can likewise be envisaged, for instance applications in the field of rating the performances of sportsmen, artists, politicians, for rating the popularity of people in a community etc.

According to a preferred embodiment of the present invention the processing means are adapted to classify inputted rating values in accordance with type of user and to modify the values assigned to the relevant value bearers as a function of type of user. The values of the relevant value bearers are thus modified in a manner which is characteristic for each type of user. A distinction can herein preferably be made between a first type of user, comprising owners of the relevant value bearers, a second type of user, comprising internet users who own no value bearers, and a third type of user, comprising a preselected group of users, preferably professional assessors. In these preferred embodiments the three types of user can each exert influence in a different way on the modification of the value of the value bearer.

According to a preferred embodiment the input means comprise an interface with a computer network, in particular the internet. The system herein functions as server, while the user who inputs the rating values functions as client.

According to a further preferred embodiment the processing means are adapted to repeat per predetermined unit of time the modification of the values assigned to each of the value bearers, whereby a value progression of the value, bearers varying in time can be realized.

According to a further preferred embodiment the processing means are adapted to additionally increase and decrease the values of a number of the value bearers by the largest respectively smallest change in value over said unit of time. A number of the value bearers, which have risen the most in rating and therefore value, can hereby be additionally rewarded in accordance with a predetermined criterion relative to less well-performing value bearers.

According to a further preferred embodiment the processing means of the system are adapted to limit to a predetermined maximum value the decrease in value of a value bearer occurring per unit of time. This provides a “safety net” for poorly performing value bearers.

According to a further preferred embodiment the processing means are adapted to allow acquisition of one or more value bearers by one or more users. A user who applies to the system, for instance via the internet, can purchase one or more value bearers and hereby joins the users in the above stated first type of user.

According to another aspect of the invention there is provided a method for changing a value assigned to a value bearer, wherein the value of the value bearer is changed in accordance with the outcome of a calculation wherein parameters resulting from particular events or facts are processed in accordance with a predetermined function. In a preferred embodiment the events or facts are formed by performances of a person or of a group of persons.

According to a preferred embodiment of the invention the value bearer is provided by a provider and, at the request of the owner thereof, taken back by the provider upon payment of the then current value thereof.

According to a preferred embodiment of the invention the value bearer is provided by a provider and taken back by the provider at a predetermined moment upon payment of the then current value thereof.

According to a further preferred embodiment the parameters are such that the chance of a determined magnitude of a parameter can be at least approximately predetermined.

According to a further preferred embodiment the value bearer is a certificate or policy, preferably linked to a person or to a group of persons, or a trademark.

Further advantages, features and details of the present invention will be elucidated in the light of a description of a preferred embodiment thereof. Reference is made in the description to the figures, in which:

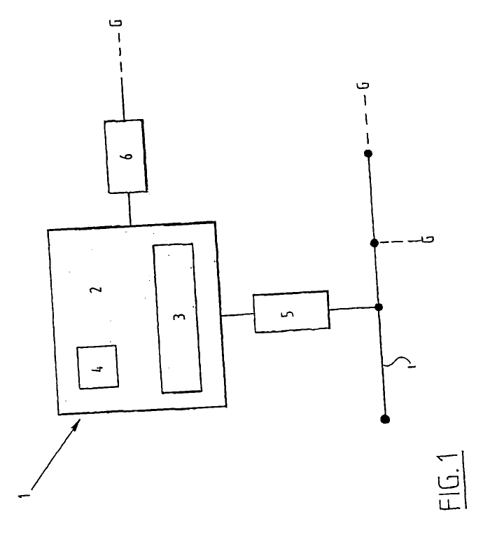

FIG. 1 shows a schematic diagram of a preferred embodiment of the system according to the invention;

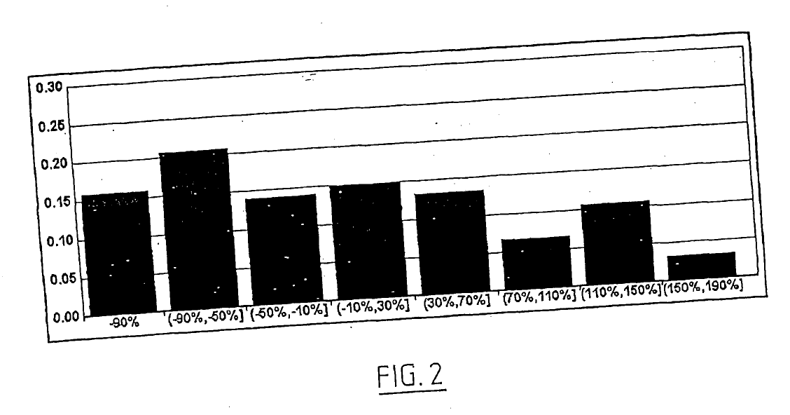

FIG. 2 shows a graph representing the results of a simulation of the method according to the invention;

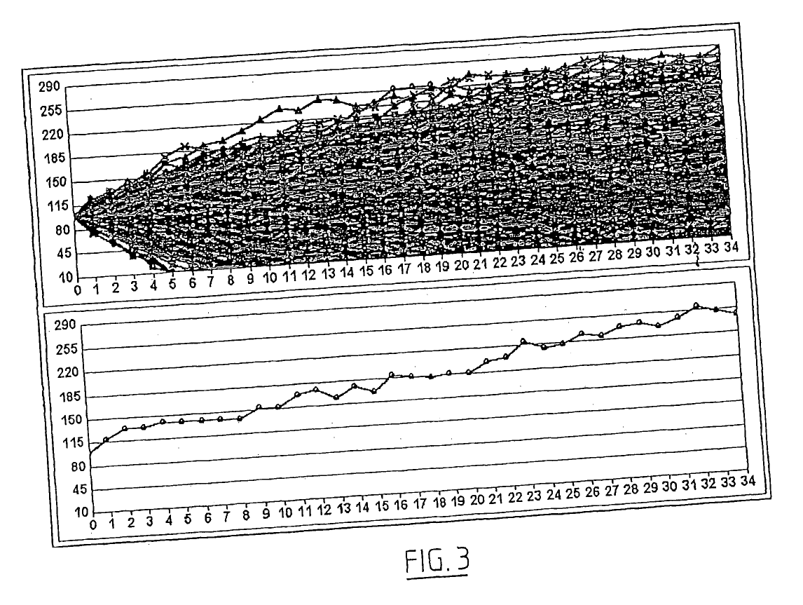

FIG. 3 shows a schematic graph of the developments in time of an index or price;

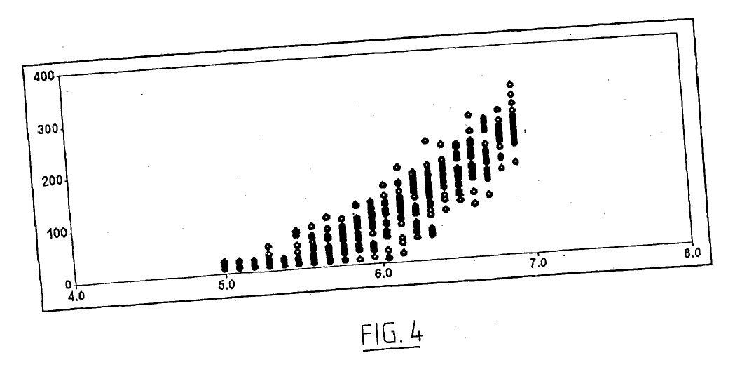

FIG. 4 shows a graph representing the index at the end of a time period as a function of the average rating score given by a professional panel; and

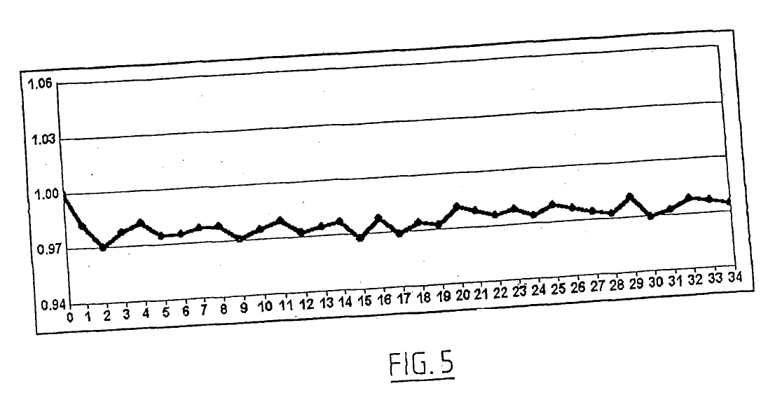

FIG. 5 shows a graph representing the behaviour of the equalization factor.

The invention is set forth below with reference to an application of the system and the method to a footballer rating system. Numerous alternatives are however possible which, depending on the application, may be given preference.

FIG. 1 shows schematically the operation of a preferred embodiment of the system 1. System 1 comprises a server computer 2 which is provided with a memory 3 and a processor unit 4, such as a microprocessor. The computer is connected via a first interface 5 to a network, preferably to the internet (i). Contact may also be established with the server computer 2 in other manner, such as for instance directly via a telephone modem 6. A large number of users G can make contact with server 2 either via the internet (i) or directly. The system is implemented on the server using computer software running on the server.

Running on server 2 in the shown example is a footballer rating system in which users G can purchase one or more “shares” in footballers playing in matches in the national football competition. These shares represent a determined rating of the footballer in question. The rating of a footballer can be expressed in an index value or price value, which value is for instance a number, but may also represent an amount of money.

The rating of a particular footballer is thus not determined by the laws of supply and demand but by a predetermined calculation method implemented in the computer program. The rating of a footballer is calculated on the basis of this calculation method and data inputted in server 2 by users and/or others either directly or via the internet. These calculations are repeated so that on each occasion, for instance once per hour, a modified rating or price is brought about.

The footballer rating system is described by the rules which are subdivided into a purchasing and sales procedure, a voting procedure and an index or price determination.

Once a user has gained access to the network address (the internet site) on which the system is implemented, he is given the option of purchasing one or more shares (securities, certificates), wherein each share is representative of a particular footballer.

At the beginning of the football competition the index of a share is set at 100 points, wherein the index of 100 points represents a value of for instance 1 euro. Such a share will therefore cost the user 1 euro. Payment of this amount preferably takes place directly via the internet, so that the user can immediately assert his rights to the share.

The value of the index of a random share is calculated by the computer software on server 2 once per unit of time, for instance once an hour. The index value of the share can be displayed to the user via interfaces 5 or 6.

Shares can be purchased by a user at any random point in time for the index value current at that moment, while the shares can be sold at the end of the competition at the most recent index value.

The index value depends on the voting behaviour of a number of parties. Voting on football players proceeds as follows. Three panels cast a vote on the performances of each of the players, or at least one particular player.

Firstly, a professional panel is provided consisting of independent reporters or journalists. Independent is understood to mean that the members of this panel have no interest in the price progression of the shares. The members of this panel can give their rating of particular footballers independently of each other or jointly by casting their votes on server 2.

Secondly, a panel is provided made up of shareholders who are all participants in the system. The shareholders also transmit their vote to server 2 via internet or directly via the telephone.

Thirdly there is a visitors panel, consisting for instance of all visitors to the web-site who do not form part of the group of shareholders but who can and must however register in one or other manner, for instance on the site.

In order to become part of the visitors panel (panel of non-shareholders), a visitor casts a vote either via an internet site or via the telephone. In order to become a member of the shareholders panel there is the additional requirement that the voter must have purchased at least one share.

The votes cast give a rating, for instance in the form of a score from one (extremely poor performance) to ten (exceptionally good performance). The professional panel votes once per round of the competition. The votes by the shareholders and the non-shareholders are limited in a manner as set forth in the following.

A maximum of one vote per voter per player is allowed. Shareholders can cast votes for players in which they have one or more shares, although their scores are limited to a maximum.

In order to obtain one vote per hour, the average is taken of the votes cast by the relevant panel during that hour.

At least one of the following four components of the function determines the index of a share:

I—the score of all three panels;

II—a redistribution of the money over the shareholders;

III—a bonus system;

IV—a safety net for shares.

Re. I Score of the Panels.

The effect of a score on the index depends on the panel and the scores:

the higher the mark score, the greater the increase in index;

the influence of the panels per index evaluation increases in the following sequence: visitors panel (panel of non-shareholders)—shareholders panel—professional panel;

the change in index per round of the competition varies between a predetermined minimum value and a predetermined maximum value, for instance −44.8 and +44.8;

if a panel gives no scores for a player, the score 6 is automatically given;

the precise influences are predetermined. A specific interpretation hereof is given in table 1.

TABLE 1

| | | | per round | | per hour | |
|---|---|---|---|---|---|---|
| | | | share- | | share- | |
| | qualification | professional | holders | visitors | holders | visitors |
| 10 | exceptionally | 17.920 | 17.920 | 8.690 | 0.107 | 0.053 |
| | good | | | | | |
| 9 | very good | 13.440 | 13.440 | 6.720 | 0.080 | 0.040 |
| 8 | good | 8.960 | 8.960 | 4.480 | 0.053 | 0.027 |
| 7 | reasonable | 4.480 | 4.480 | 2.240 | 0.027 | 0.013 |
| 6 | average | 0.000 | 0.000 | 0.000 | 0.000 | 0.000 |
| 5 | unsatisfactory | −3.584 | −3.584 | −1.792 | −0.021 | −0.011 |
| 4 | mediocre | −7.168 | −7.168 | −3.584 | −0.043 | −0.021 |
| 3 | poor | −10.752 | −10.752 | −5.376 | −0.064 | −0.032 |
| 2 | very poor | −14.336 | −14.336 | −7.168 | −0.085 | −0.043 |
| 1 | exceptionally | −17.920 | −17.920 | −8.960 | −0.107 | −0.053 |
| | poor | | | | | |

The values shown in the table are stored in appropriate form in the memory 3 of computer 2.

Suppose for instance that an index of shares in a particular player is initially 100. Suppose further that during one hour the professional panel gives a score of seven, and the shareholders panel and the visitors panel give an average score of 7.3 and 5.9, where the average is taken over all scores given by these panels during this particular hour. The new index or rating value will then become:

100+(4.48)+(0.027+(7.3−7)*(0.053−0.027))+(−0.011+(5.9−5)*(0+0.011))=100+4.48+0.0348−0.0011=104.5137.

Re. II Distribution of the Money Over the Shareholders.

The total invested sum is redistributed over all shareholders by applying an equalization factor to all indices:

new index=equalization factor*index after changes resulting from panels

The equalization factor is calculated as follows:

Equalization factor=value of shares prior to the changes brought about by the panels/value of shares after the changes brought about by the panels.

If there are 300 players with 2000 shares who each have a value of 100 and receive a score of 7 from all panels, the equalization factor for this index evaluation will then be:

300*2000*100/(300*2000*100(1+4,48+0.027+0.013))=0.96

Re. III A Bonus System.

Each round of the competition the shares of the best 5% of the players is increased by 1%: the bonus. The best 5% of the players are the players who have received the best scores from the panels since the previous round of the competition. This bonus can be given by proportionally decreasing the shares of the other 95% of the players in order to finance the bonus system.

Suppose for instance that there are 300 players and 2000 shares per player. Suppose further that before a new index evaluation is carried out, all shares have an index of 100. As a result of the panels and the equalization factor 285 players (95% of the players) have an index decrease of 1 point, which results in an index of 99, while the index of shares in 15 players (i.e. 5% of the players) increases by 19 points, which results in an index of 119. The bonus system rewards the 15 best players by having their index increase by 1% to 120.19. Creaming off the index of the remaining shares finances these bonuses:

(285*2000*99+15*2000*(119−120.19))/285*2000=98.94

Re. IV Safety Net for Shares.

A safety net minimizes extreme losses. If the index drops to below 10, the index is increased again to 10. The other shares finance this safety net in proportion to the index.

Suppose that there are 300 players and 2000 shares per player. Suppose further that, as a result of the panels, the equalization factor and the bonus system the index of shares in 50 players has decreased to 8 points, while the index of the shares in the other 250 players has become 118.4. In this case the safety net increases the index of the 100,000 shares from index 8 to index 10 and the safety net creams off the index of the 500,000 shares to:

(50*2000*(8−10)+250*2000*118.4)/(250*2000)=118.

In order to verify whether the function set forth above meets all criteria, an extensive simulation study has been carried out. In this study many different scenarios are designed for the voting behaviour of the three panels. The effect of the simulated scores on the individual index of 457 players in the football competition was calculated 5712 times (once for every hour on each day in the period in which the 34 rounds of the competition were played). Different scenarios for the acquisition of shares were likewise taken into account.

FIG. 2 shows the outcomes of one simulation for which both a score behaviour scenario and a share acquisition scenario were chosen. Although the results depend on the selected scenarios, the graphs shown in the figure are representative of many such scenarios. The graphs therefore give an indication of how well the criteria will generally be met. In FIG. 2 is shown a relative frequency diagram showing the fraction of the shares (vertical axis) with a Return on Investment which lies in the interval indicated on the horizontal axis at the end of the competition. The diagram shows that 21% of the shares have a Return on Investment which is greater than 70%, which corresponds with a final index of 170 or higher.

FIG. 3 represents the development of the index of all shares (top graph) and that of a selected player (bottom graph) per round of the competition. The index development is reasonably mobile: the average relative change per round of the competition of all players is 8.3%, while on average in 18 of the 34 rounds of the competition an index increase was followed by an index decrease, or vice versa. For the selected player these figures are respectively 4.8% and 17 times.

FIG. 4 shows a graph in which all 457 players are represented by a dot. The location of a dot indicates the index of the shares in the player at the end of the competition (vertical axis) and the expected average numeric score given by the professional panel (horizontal axis). The shape of the cloud formed by the dots indicates that the final index displays a good correlation to the expected average numeric score.

FIG. 5 represents the behaviour of the equalization factor during the competition. It can be inferred from the figure that this factor lies close to the value one, which indicates that the equalization factor does not influence the index substantially, so that all users will consider the index as a reliable value.

The invention is not limited to the above described preferred embodiment thereof; the rights sought are defined by the following claims, within the scope of which many modifications can be envisaged. Also falling within the scope of the claims are for instance products or methods derived from the system or the method according to the invention wherein use is made of the values determined according to the invention of one or more value bearers or the certificates, policies and the like associated with the value bearers.

1. System for changing the initial values assigned to one or more value bearers, comprising:
memory means for storing data representative of the initial value assigned to a value bearer,
input means for inputting one or more rating values for a particular event or a particular fact;
processing means for modifying in predetermined manner, subject to the inputted rating values, the initial values assigned to the value bearers and storing the changed values assigned to the value bearers in the memory means.

2. System as claimed in claim 1, wherein the processing means are adapted to classify inputted rating values in accordance with type of user and to modify the values assigned to the relevant value bearers as a function of type of user.

3. System as claimed in claim 2, wherein the processing means are adapted to repeat per predetermined unit of time the modification of the values assigned to each of the value bearers.

4. System as claimed in claim 3, wherein the processing means are adapted to additionally increase and decrease the values of a number of the value bearers by the largest respectively smallest change in value over said unit of time.

5. System as claimed in any of the foregoing claims, wherein the predetermined method of modification is determined in a rating function stored in the memory means.

6. System as claimed in claim 5, wherein the rating function comprises an equalization factor.

7. System as claimed in any of the claims 3-6, wherein the processing means are adapted to limit to a predetermined maximum value the decrease in value of a value bearer occurring pet unit of time.

8. System as claimed in any of the foregoing claims, wherein the processing means are adapted to allow acquisition of one or more value bearers by one or more users.

9. System as claimed in any of the claims 2-8, wherein a first type of user comprises owners of value bearers.

10. System as claimed in any of the foregoing claims, wherein the input means comprise an interface with a computer network, in particular the internet.

11. System as claimed in any of the claims 2-10, wherein a second type of user comprises internet users.

12. System as claimed in any of the claims 2-11, wherein a third type of user comprises a preselected group of users, preferably professional assessors.

13. System as claimed in any of the foregoing claims, comprising means for sending to the user the initial value and/or modified value of a value bearer.

14. Method for changing a value assigned to a value bearer, wherein the value of the value bearer is changed in accordance with the outcome of a calculation wherein parameters resulting from particular events or facts are processed in accordance with a predetermined function.

15. Method as claimed in claim 14, wherein the value bearer is provided by a provider and, at the request of the owner thereof, taken back by the provider upon payment of the then current value thereof.

16. Method as claimed in claim 14, wherein the value bearer is provided by a provider and taken back by the provider at a predetermined moment upon payment of the then current value thereof.

17. Method as claimed in any of the claims 14-16, wherein the parameters are such that the chance of a determined magnitude of a parameter can be at least approximately predetermined.

18. Method as claimed in any of the claims 14-17, wherein an event or fact is a performance of a person or of a group of persons.

19. Method as claimed in any of the claims 14-18, wherein an event or fact is a temporary condition which cannot be influenced.

20. Method as claimed in any of the claims 14-19, wherein the value bearer is a certificate.

21. Method as claimed in any of the claims 14-19, wherein the value bearer is a policy.

22. Method as claimed in claim 20 or 21, wherein the certificate or the policy is linked to a person or to a group of persons.

23. Method as claimed in any of the foregoing claims, wherein the value bearer is a trademark.

24. System comprising a computer for determining for each value bearer the relevant change in the value thereof, which computer is programmed to execute the method as claimed in any of the claims 14-23.

25. System as claimed in claim 24 and at least one of the claims 1-13.

26. Computer program comprising computer program code means which are adapted to drive the processing means of a system as claimed in any of the claims 1-13, 24-25, when said program is run on a computer.

27. Carrier medium, in particular an electromagnetic signal, evidently intended for executing the method as claimed in any of the claims 14-23 or for application in a system as claimed in any of the claims 1-13, 24, 25.

29. The system according to claim 28, wherein the values assigned to the value bearers are modified repeatedly per predetermined unit of time.

30. The system according to claim 28, wherein the rating function comprises a table of possible rating values and corresponding modified values, based on which the values of the value bearers are modified.

31. The system as claimed in claim 28, wherein the modified values are positive and negative values for rating values larger than respectively smaller than an average rating value.

32. The system as claimed in claim 28, wherein the processing means are adapted to classify inputted rating values in accordance with type of user and to modify the values assigned to the relevant value bearers as a function of type of user.

33. The system as claimed in claim 28, wherein the processing means are adapted to additionally increase and decrease the values of a number of the value bearers by the largest respectively smallest change in value over said unit of time.

34. The system according to claim 28, wherein the rating function comprises an equalization factor.

35. The system as claimed in claim 30, wherein the processing means are adapted to limit to a predetermined maximum value the decrease in value of a value bearer occurring per unit of time.

36. The system as claimed in claim 28, wherein the processing means are adapted to allow acquisition of one or more value bearers by one or more users.

37. The system as claimed in claim 28, wherein a first type of user comprises owners of value bearers.

38. The system as claimed in claim 28, wherein the input means comprise an interface with a computer network, in particular the internet.

39. The system as claimed in claim 28, wherein a second type of user comprises internet users.

40. The system as claimed in claim 28, wherein a third type of user comprises a preselected group of users, preferably professional assessors.

41. The system as claimed in claim 28, comprising means for sending to the user the initial value and/or modified value of a value bearer.

42. A method for changing a value assigned to a value bearer, wherein the value of the value bearer is repeatedly modified in accordance with the outcome of a calculation wherein parameter values resulting from particular events or facts are processed in accordance with a predetermined rating function.

43. The method according to claim 42, comprising modifying the value of a value bearer repeatedly per a predetermined unit of time.

44. The method according to claim 43, wherein the rating function comprises possible parameter values and corresponding modified values, the modified values being used to modify the values of the value bearer.

45. The method according to claim 42, wherein the modified values are positive and negative values for parameter values larger than respectively smaller than an average parameter value.

46. The method as claimed in claim 42, wherein the value bearer is provided by a provider and, at the request of the owner thereof, taken back by the provider upon payment of the then current value thereof.

47. The method as claimed in claim 42, wherein the value bearer is provided by a provider and taken back by the provider at a predetermined moment upon payment of the then current value thereof.

48. The method as claimed in claim 42, wherein the parameters are such that the chance of a determined magnitude of a parameter can be at least approximately predetermined.

49. The method as claimed in claim 42, wherein an event or fact is a performance of a person or of a group of persons.

50. The method as claimed in claim 42, wherein an event or fact is a temporary condition which cannot be influenced.

51. The method as claimed in claim 42, wherein the value bearer is a certificate.
